(19) United States
(12) Patent Application Publication
(10) Pub. No.: US 2023/0069363 A1
(43) Pub. Date: Mar. 2, 2023

(54) METHODS AND SYSTEMS FOR DYNAMIC FLEET PRIORITIZATION MANAGEMENT

(71) Applicant: GM GLOBAL TECHNOLOGY OPERATIONS LLC, Detroit, MI (US)

(72) Inventors: Lawrence A. Bush, Shelby Township, MI (US); Joseph F. Szczerba, Grand Blanc, MI (US); Roy J. Mathieu, Rochester Hills, MI (US)

(73) Assignee: GM GLOBAL TECHNOLOGY OPERATIONS LLC, Detroit, MI (US)

(21) Appl. No.: 17/409,979

(22) Filed: Aug. 24, 2021

(51) Int. Cl. G05D 1/00; B60W 60/00

(52) U.S. Cl. CPC G05D 1/0055; G05D 1/0011; B60W 60/001; B60W 2555/20; B60W 2554/406

(57) ABSTRACT

Systems and method are provided for requesting remote control of an autonomous vehicle by a remote transportation system. In one embodiment, a method includes: receiving, by a processor of the autonomous vehicle, experience data associated with the autonomous vehicle, wherein the experience data includes a location of the autonomous vehicle, a time of day, a pose of the autonomous vehicle, detected freespace in an environment of the autonomous vehicle, detected congestion in the environment, a planned maneuver type, and an associated maneuver graph; determining, by the processor, one or more features of a planned maneuver based on the experience data; determining, by the processor, a risk value associated with the planned mission by processing the one or more features with a machine learning model; and selectively generating, by the processor, request data to the remote transportation system based on the risk value, wherein the request data includes the risk value.

### TECHNICAL FIELD

The present disclosure generally relates to vehicles, and more particularly relates to systems and methods for managing assistance provided to autonomous vehicles in a fleet of autonomous vehicles.

A number of vehicles have one or more autonomous features. For example, an autonomous vehicle is a vehicle that is capable of sensing its environment and navigating with little or no user input. It does so by using sensors such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle.

In certain circumstances, it may be necessary for an operator to step in and provide assistance to the autonomous vehicle. In such circumstances, the assistance may be requested from a remote operator at a remote location. For example, the remote operator may oversee a fleet of the autonomous vehicles.

Accordingly, it is desirable to provide systems and methods for managing assistance provided to autonomous vehicles in a fleet of autonomous vehicles. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for requesting remote control of an autonomous vehicle by a remote transportation system. In one embodiment, a method includes: receiving, by a processor of the autonomous vehicle, experience data associated with the autonomous vehicle, wherein the experience data includes a location of the autonomous vehicle, a time of day, a pose of the autonomous vehicle, detected freespace in the environment, detected congestion in an environment of the autonomous vehicle, a planned maneuver type, and an associated maneuver graph; determining, by the processor, one or more features of a planned maneuver based on the experience data; determining, by the processor, a risk value associated with the planned mission by processing the one or more features with a machine learning model; and selectively generating, by the processor, request data to the remote transportation system based on the risk value, wherein the request data includes the risk value.

In various embodiments, the one or more features includes a second risk value associated with a control type or level of a proximal intersection.

In various embodiments, the one or more features includes a failure probability value based on a prior map.

In various embodiments, the one or more features includes a time of day failure probability value based on a time of day prior map.

In various embodiments, the one or more features includes a maneuver contingency risk value.

In various embodiments, the one or more features includes a maneuver type risk value.

In various embodiments, the one or more features includes a freespace maneuverability risk value.

In various embodiments, the one or more features includes a congestion level risk value.

In various embodiments, the method includes selectively assigning, by the remote transportation system, an operator to the autonomous vehicle to provide remote assistance based on the request data.

In various embodiments, the request data includes an intervention type and wherein the method further comprises prioritizing, by the remote transportation system, the intervention type based on the request data.

In various embodiments, the method includes: determining, by the remote transportation system, one or more additional features of the planned maneuver; and updating, by the remote transportation system, the risk value associated with the planned mission by processing the one or more of the additional features with a machine learning model.

In various embodiments, the one or more additional features includes a weather type risk value.

In various embodiments, the one or more additional features includes a congestion risk value.

In various embodiments, the one or more additional features includes a prior map probability value.

In another embodiment, a system includes: a communication system configured to communicate request data that requests intervention of autonomous control to the remote transportation system; and a controller configured to, by a processor, receive experience data associated with the autonomous vehicle, wherein the experience data includes a location of the autonomous vehicle, a time of day, a pose of the autonomous vehicle, detected freespace in the environment, detected congestion in an environment of the autonomous vehicle, a planned maneuver type, and an associated maneuver graph, wherein the controller is further configured to determine one or more features of a planned maneuver based on the experience data, determine a risk value associated with the planned mission by processing the one or more features with a machine learning model, selectively generate the request data based on the risk value, wherein the request data includes the risk value.

In various embodiments, the one or more features includes at least one of a second risk value associated with a control type or level of a proximal intersection, a failure probability value based on a prior map, a time of day failure probability value based on a time of day prior map, a maneuver contingency risk value, a maneuver type risk value, a freespace maneuverability risk value, and a congestion level risk value.

In various embodiments, the system includes the remote transportation system configured to, by a processor, determine one or more additional features of the planned maneuver, and update the risk value associated with the planned mission by processing the one or more of the additional features with at least one additional machine learning model.

In various embodiments, the one or more additional features are associated with at least one of a weather type, a congestion level, and a prior map.

In various embodiments, the system includes the remote transportation system, wherein the remote transportation system is configured to assign an operator to the autonomous vehicle to provide remote assistance based on the request data.

In various embodiments, the request data includes an intervention type, and wherein the system further comprises the remote transportation system, wherein the remote transportation system is configured to prioritize the intervention type based on the request data.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating a vehicle having a fleet management system, in accordance with various embodiments;

FIG. 2 is a functional block diagram illustrating a transportation system having one or more vehicles as shown in FIG. 1 and a fleet management system, in accordance with various embodiments;

FIG. 3 is functional block diagram illustrating an autonomous driving system (ADS) having the fleet management system associated with the vehicle of FIG. 1, in accordance with various embodiments;

FIG. 4 is a functional block diagram illustrating the fleet management system of the vehicle, in accordance with various embodiments; and

FIG. 5 is a flowchart for a control process of the fleet management system of a vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

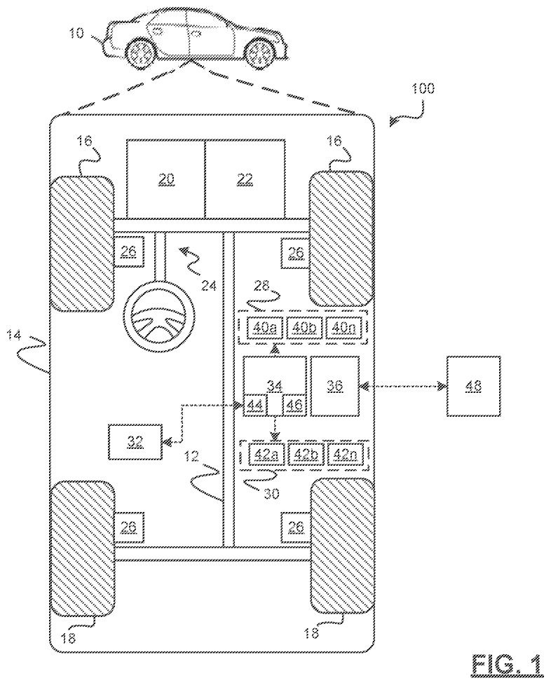

With reference to FIG. 1, a fleet management system shown generally as 100 is associated with a vehicle 10 in accordance with various embodiments. In general, the fleet management system (or simply “system”) 100 of the vehicle 10 provides for a risk self-reporting system that determines self-risk associated with a mission and requests human intervention based on the risk.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 comprise a wheel assembly that also includes respective associated tires.

In various embodiments, the vehicle 10 is an autonomous vehicle, and the sensor alignment adjustment system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

In an exemplary embodiment, the vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories. Furthermore, systems in accordance with the present embodiment may be used in conjunction with any autonomous, non-autonomous, or other vehicle that includes sensors and a suspension system.

As shown, the vehicle 10 generally includes a propulsion system 20, a transmission system 22, a steering system 24, a brake system 26, a suspension system 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel for illustrative purposes, in some embodiments contemplated within the scope of the present disclosure, the steering system 24 may not include a steering wheel.

The suspension system 27 connects the vehicle 10 and the wheels 16, 18. In various embodiments, the suspension system 27 provides support for different qualities of operation of the vehicle 10 that include road holding (e.g., steering stability), road handling (e.g., cornering), and road isolation (e.g., ride comfort). Also in various embodiments, the suspension system 27 includes one or more shock absorbers 71, springs 72 (e.g., in one embodiment, one or more airbags serving as springs 72), one or more adjustment systems 73 (e.g., a hydraulic system, electromagnetic system, and/or electromechanical system), and/or one or more other components (e.g., linkages, tires associated with the wheels 16, 18, actuators, and the like, among other possible components) that affect relative motion between the vehicle 10 and the wheels 16, 18.

In various embodiments, the suspension system 27 is an adjustable suspension system, in which one or more components thereof may be adjusted via respective actuators. In various embodiments, the suspension system 27 is adjustable in order to adjust road isolation, road handling, ride height above one or more wheels in contact with the ground, and/or road isolation for the vehicle 10. Also in various embodiments, the suspension system 27 is further adjustable in order to adjust an alignment of sensors of the sensor system 28 in certain appropriate circumstances.

The sensor system 28 includes one or more sensors 40a-40n that sense observable conditions of the exterior environment and/or the interior environment of the vehicle 10. The sensors 40a-40n include, but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, the propulsion system 20, the transmission system 22, the steering system 24, the brake system 26, and the suspension system 27. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

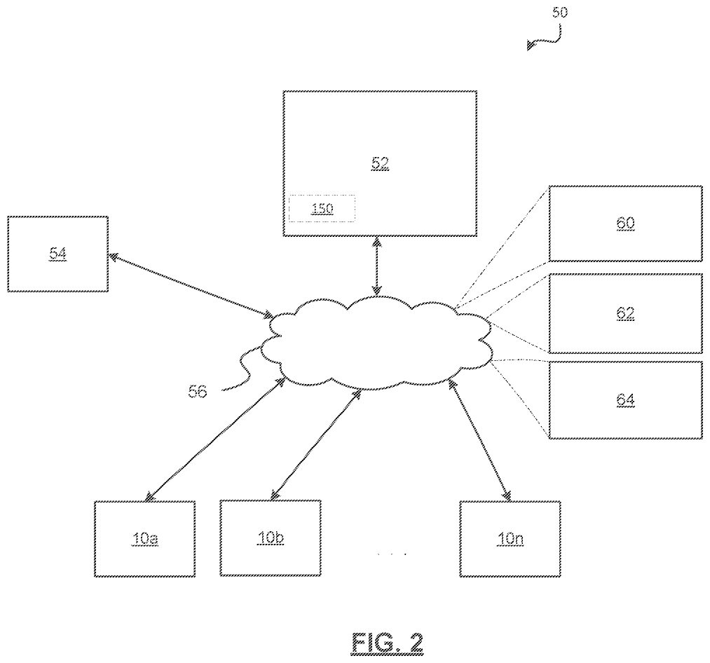

The data storage device 32 stores data for use in automatically controlling the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. Route information may also be stored within data storage device 32—i.e., a set of road segments (associated geographically with one or more of the defined maps) that together define a route that the user may take to travel from a start location (e.g., the user's current location) to a target location.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In certain embodiments, the communication system 36 is further configured for communication between the sensor system 28, the actuator system 30, one or more controllers (e.g., the controller 34). For example, the communication system 36 may include any combination of a controller area network (CAN) bus and/or direct wiring between the sensor system 28, the actuator system 30, and/or one or more controllers 34.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, as discussed in detail below, the controller 34 is configured for use in determining a self-risk and communicating the self-risk and/or a request for remote assistance to the fleet management system 100 of the remote transportation system 52.

With reference now to FIG. 2, in various embodiments, the vehicle 10 described with regard to FIG. 1 may be suitable for use in the context of fleet of vehicles such as a taxi or shuttle service in a certain geographical area (e.g., a city, a school or business campus, a shopping center, an amusement park, an event center, or the like) or may simply be managed by a remote system. For example, the vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more vehicles 10a-10n as described with regard to FIG. 1. In various embodiments, the operating environment 50 (all or a part of which may correspond to entities 48 shown in FIG. 1) further includes one or more user devices 54 that communicate with the vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the vehicles 10a-10n. This can be done using one or more communication satellites (not shown) and an uplink transmitting station (not shown). Uni-directional communication can include, for example, satellite radio services, wherein programming content (news, music, and the like) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a plurality of live advisors, automated advisors, an artificial intelligence system, or a combination thereof. The remote transportation system 52 can communicate with the user devices 54 and the vehicles 10a-10n to schedule rides, dispatch vehicles 10a-10n, and the like.

In various embodiments, the remote transportation system 52 includes remote assistance system 150 that is a part of the fleet management system 100. The remote assistance system 150 communicates with the fleet management system 100 of the vehicle to provide remote assistance to a requesting vehicle based on the self-assessed risk. In various embodiments, the remote assistance system 150 dynamically assigns a remote operator to the vehicle 10a to provide the assistance based on the self-assessed risk that the vehicle 10a communicates to the remote transportations system 52.

In accordance with a typical use case workflow, when a vehicle 10a of the vehicles 10a-10b determines that assistance may be needed, the vehicle 10a computes a risk value based on a determined need for assistance to successfully complete a mission. The vehicle 10a can determine an intervention type needed to complete the mission and communicate the risk and intervention type to the remote transportation system 52. The remote transportation system 52 evaluates the risk and the intervention type and dynamically assigns an intervention task to an operator of the remote transportation system 52, for example, based on a prioritization of the risk and/or the task type.

As can be appreciated, the subject matter disclosed herein provides certain enhanced features and functionality to what may be considered as a standard or baseline vehicle 10 and/or a vehicle based remote transportation system 52. To this end, a vehicle and a vehicle based remote transportation system can be modified, enhanced, or otherwise supplemented to provide the additional features described in more detail below.

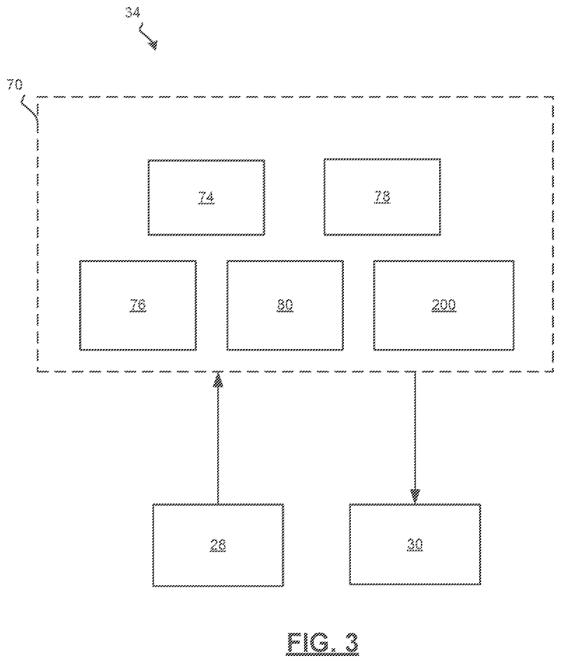

In accordance with various embodiments, the controller 34 implements an autonomous driving system (ADS) as shown in FIG. 3. That is, suitable software and/or hardware components of the controller 34 (e.g., processor 44 and computer-readable storage device 46) are utilized to provide an ADS that is used in conjunction with vehicle 10.

In various embodiments, the instructions of the autonomous driving system 70 may be organized by function or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, as discussed above with regard to FIG. 1, one or more instructions of the controller 34 are embodied in the risk assessment system 200 of the fleet management system 100. All or parts of the risk assessment system 200 may be embodied in one of the sub-systems 74-80 of the ADS 70 or may be implemented as a separate system 200, as shown.

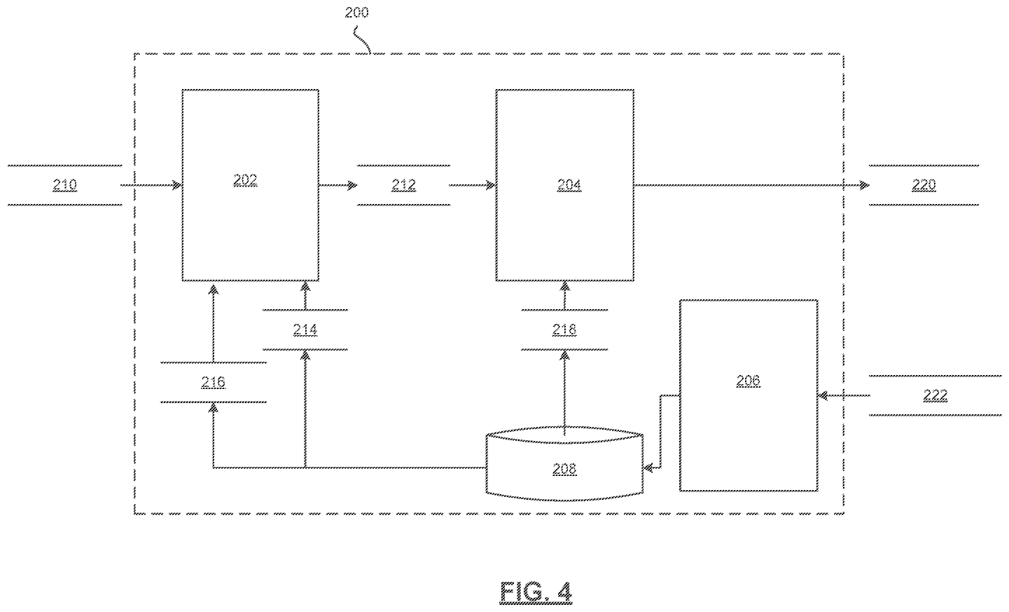

Referring to FIG. 4 and with continued reference to FIG. 1-3, a dataflow diagram illustrates the risk assessment system 200 of the system 100 in accordance with various embodiments. It will be understood that various embodiments of the risk assessment system 200 according to the present disclosure may include any number of sub-modules which may be combined and/or further partitioned to similarly implement systems and methods described herein. Furthermore, inputs to the risk assessment system 200 may be received from the sensor system 28, retrieved from the data storage device 32, received from other control modules (not shown) associated with the autonomous vehicle 10, received from the communication system 36, and/or determined/modeled by other sub-modules (not shown) within the controller 34 of FIG. 1. Furthermore, the inputs may also be subjected to preprocessing, such as sub-sampling, noise-reduction, normalization, feature-extraction, missing data reduction, and the like. In various embodiments, one or more of the modules shown may be implemented on the remote transportation system 52 and the inputs received from the vehicles 10a-10b.

In various embodiments, the risk assessment system 200 generally includes a feature determination module 202, a risk assessment module 204, a model update module 206, and a model datastore 208. The model datastore 208 stores the one or more machine learning models used in estimating a risk of completing a mission and/or models used in predicting features of a maneuver and/or a type of intervention. One or more of the models may be implemented as one or more machine learning models that undergo supervised, unsupervised, semi-supervised, or reinforcement learning. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models. In various embodiments, training of any of the models is performed by the model update module. In other embodiments, training occurs at least in part within the controller 34 of vehicle 10, itself. The models may be subsequently shared with external systems and/or other vehicles in a fleet (such as depicted in FIG. 2). In various embodiments, training may take place within a system remote from vehicle 10 (e.g., system 52 in FIG. 2) and subsequently downloaded to vehicle 10 for use during normal operation of vehicle 10.

The feature determination module 202 receives as input experience data 210. The experience data 210 includes, for example, a location of the vehicle 10, a time of day, a pose of the vehicle 10, detected freespace in an environment of the vehicle 10, detected congestion in the environment, a planned maneuver type, and an associated maneuver graph. The feature determination module 202 processes the experience data 210 with one or more machine learning models (model data 214) or prior maps (map data 2160 including maps produced from a history of the maneuver) to determine features of the planned maneuver and associate a risk or probability value with the feature.

For example, the feature determination module 202 determines a risk value associated with a control type or level of a proximal intersection. In another example, the feature determination module 202 determines a failure probability value based on a prior map. In another example, the feature determination module 202 determines a time of day failure probability value based on a time of day prior map. In another example, the feature determination module 202 determines a maneuver contingency risk value. In another example, the feature determination module determines a maneuver type risk value. In another example, the feature determination module 202 determines a freespace maneuverability risk value. In another example, the feature determination module 202 determines a weather type risk value. In another example, the feature determination module 202 determines a congestion level risk value. The feature determination module 202 then forms feature data 212 based on the determined values (e.g., as an enumeration of the determined values).

The risk assessment module 204 receives as input the feature data 212. The risk assessment module 204 processes the feature data 212 with the one or more machine learning models (model data 218) to determine risk data. For example, the machine learning model evaluates each of the features to determine a probability of successful mission completion and a risk of failure of the mission and/or a chance of needing assistance from a central operator. When it is determined that there is a chance of needing assistance, the risk assessment module 204 then determines an intervention type based on the chance of needing assistance.

The risk assessment module 204 then evaluates the risk data and selectively communicates request data 220 to, for example, the remote transportation system 52. For example, when the risk data indicates a change in risk greater than a predefined threshold, the communication module generates request data 220 indicating the risk value and the intervention type and initiates communication of the request data 220 to the remote transportation system 52.

The model update module 206 receives as input observation data 222. The observation data 222 includes pass and/or failure data associated with a feature or maneuver. The model update module 206 trains the machine learning models stored in the model datastore 208 based on the observation data 222. For example, the model update module 206 performs a temporal difference learning algorithm on the experience data 210 data replayed in time order) and the resulting observation data 222 to determine states leading up to a failure moment. These states are used to update the machine learning models saved in the model datastore 208.

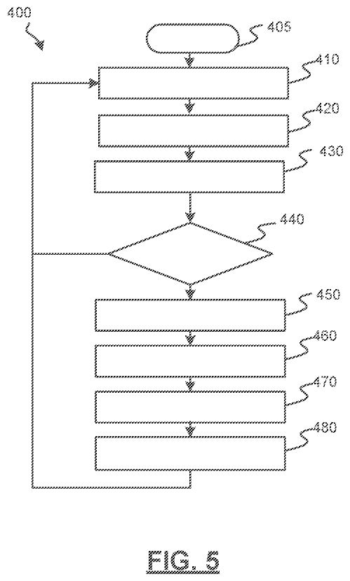

With reference to FIG. 5, a flowchart is provided for a control process 400 for performing a risk assessment by the vehicle 10, in accordance with an exemplary embodiment. In accordance with various embodiments, the control process 400 can be implemented in connection with the system 100 and vehicle 10 of FIG. 1, the transportation system 52 of FIG. 2, the autonomous driving system of FIG. 3, and the risk assessment system 200 of FIG. 4, in accordance with various embodiments. As can be appreciated in light of the disclosure, the order of operation within the control process 400 is not limited to the sequential execution as illustrated in FIG. 5 but may be performed in one or more varying orders as applicable and in accordance with the present disclosure. In various embodiments, the control process 400 can be scheduled to run based on one or more predetermined events, and/or can run continuously during operation of the vehicle 10.

In one example, the method may begin at 405. The experience data 210 is received at 410. The feature data 212 is determined based on the experience data 210 at 420. For example, as discussed above, the feature data 212 includes a risk value associated with a control type or level of a proximal intersection, a failure probability value based on a prior map, a time of day failure probability value based on a time of day prior map, a maneuver contingency risk value, a maneuver type risk value, a freespace maneuverability risk value, a weather type risk value, and/or a congestion level risk value.

The feature data 212 is processed by the machine learning model to determine the risk at 430. A change in risk is determined and compared to a predefined threshold at 440. If the change in risk is greater than the threshold at 440, the control process 400 continues with determining the intervention type at 450 and generating request data 220 based thereon at 460. Thereafter, observation data 222 is received at 470 and the machine learning model is selectively updated using the experience data 210 and the observation data 222 at 480. Thereafter, the control process 400 may continue with receiving new experience data at 410.

Once the request data 220 is received by the remote transportation system 52, the risk and intervention type can be used to assign an operator to the requesting vehicle and/or prioritize intervention of control of the vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for requesting remote control of an autonomous vehicle by a remote transportation system, comprising
receiving, by a processor of the autonomous vehicle, experience data associated with the autonomous vehicle, wherein the experience data includes a location of the autonomous vehicle, a time of day, a pose of the autonomous vehicle, detected freespace in the environment, detected congestion in an environment of the autonomous vehicle, a planned maneuver type, and an associated maneuver graph;
determining, by the processor, one or more features of a planned maneuver based on the experience data;
determining, by the processor, a risk value associated with the planned mission by processing the one or more features with a machine learning model; and
selectively generating, by the processor, request data to the remote transportation system based on the risk value, wherein the request data includes the risk value.

2. The method of claim 1, wherein the one or more features includes a second risk value associated with a control type or level of a proximal intersection.

3. The method of claim 1, wherein the one or more features includes a failure probability value based on a prior map.

4. The method of claim 1, wherein the one or more features includes a time of day failure probability value based on a time of day prior map.

5. The method of claim 1, wherein the one or more features includes a maneuver contingency risk value.

6. The method of claim 1, wherein the one or more features includes a maneuver type risk value.

7. The method of claim 1, wherein the one or more features includes a freespace maneuverability risk value.

8. The method of claim 1, wherein the one or more features includes a congestion level risk value.

9. The method of claim 1, further comprising selectively assigning, by the remote transportation system, an operator to the autonomous vehicle to provide remote assistance based on the request data.

10. The method of claim 1, wherein the request data includes an intervention type and wherein the method further comprises prioritizing, by the remote transportation system, the intervention type based on the request data.

11. The method of claim 1, further comprising determining, by the remote transportation system, one or more additional features of the planned maneuver; and
updating, by the remote transportation system, the risk value associated with the planned mission by processing the one or more of the additional features with a machine learning model.

12. The method of claim 11, wherein the one or more additional features includes a weather type risk value.

13. The method of claim 11, wherein the one or more additional features includes a congestion risk value

14. The method of claim 11, wherein the one or more additional features includes a prior map probability value.

15. A system for requesting remote control of an autonomous vehicle by a remote transportation system, comprising:
a communication system configured to communicate request data that requests intervention of autonomous control to the remote transportation system; and
a controller configured to, by a processor, receive experience data associated with the autonomous vehicle, wherein the experience data includes a location of the autonomous vehicle, a time of day, a pose of the autonomous vehicle, detected freespace in the environment, detected congestion in an environment of the autonomous vehicle, a planned maneuver type, and an associated maneuver graph, wherein the controller is further configured to determine one or more features of a planned maneuver based on the experience data, determine a risk value associated with the planned mission by processing the one or more features with a machine learning model, selectively generate the request data based on the risk value, wherein the request data includes the risk value.

16. The system of claim 15, wherein the one or more features includes at least one of a second risk value associated with a control type or level of a proximal intersection, a failure probability value based on a prior map, a time of day failure probability value based on a time of day prior map, a maneuver contingency risk value, a maneuver type risk value, a freespace maneuverability risk value, and a congestion level risk value.

17. The system of claim 15, the remote transportation system configured to, by a processor, determine one or more additional features of the planned maneuver, and update the risk value associated with the planned mission by processing the one or more of the additional features with at least one additional machine learning model.

18. The system of claim 17, wherein the one or more additional features are associated with at least one of a weather type, a congestion level, and a prior map.

19. The system of claim 17, further comprising the remote transportation system, wherein the remote transportation system is configured to assign an operator to the autonomous vehicle to provide remote assistance based on the request data.

20. The system of claim 15, wherein the request data includes an intervention type, and wherein the system further comprises the remote transportation system, wherein the remote transportation system is configured to prioritize the intervention type based on the request data.
